(19) United States
(12) Patent Application Publication
(10) Pub. No.: US 2009/0083701 A1
(43) Pub. Date: Mar. 26, 2009

(54) MULTIPLE SCHEDULERS

(75) Inventors: Blair LeDUC, Mount Hope (CA); Craig Degruchy, Mount Hope (CA); James Fernandes, Mississauga (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Thermo CRS, LTD., Burlington (CA)

(21) Appl. No.: 12/238,175

(22) Filed: Sep. 25, 2008

Related U.S. Application Data
(60) Provisional application No. 60/960,309, filed on Sep. 25, 2007.

(51) Int. Cl. G06F 9/44; G06F 9/45; G06F 17/30

(52) U.S. Cl. 717/108; 717/137; 707/102; 707/E17.055

(57) ABSTRACT

A software platform on a computer readable medium, includes a first unit for input representing a process, a second unit receiving the input from the first unit and converting the input into a neutral format process model, a first memory storing object information from the second unit, and a third unit being replaceable and receiving the neutral format process model information and converting into a language for processing in a runtime engine.

### CROSS-REFERENCE TO RELATED APPLICATIONS

This application is a non-provisional of Provisional Patent Application 60/960,309 filed Sep. 25, 2007, the entire contents of which are incorporated herein by reference.

### FIELD OF THE INVENTION

The present invention relates generally to software. More particularly, the present invention relates to a platform for software.

### BACKGROUND OF THE INVENTION

There has been an increased demand for software over the recent years and the demand is growing exponentially. The rapid growth is due partly because of the use of software in so many facets of industry, business and everyday life of people. However, because of the increased demand, there needs to be increased resources or efficiency. The increased efficiency drives cost down as opposed to simply increasing the resources used. If efficiency is not increased, then the supply of software will not meet demand.

A software factory is defined as a software product line that configures extensible development tools with packaged content based on recipes for building specific kinds of applications. The software factory basically provides a production facility for the software. The configuration of the development tools can use a software template based on a software schema. The software template can include code and metadata that can be loaded into extensible tools, while the software schema is a document that categorizes and summarizes the artifacts used to build and maintain the systems and to define the relationship between them.

Currently, there is no software factory defined for the automation field that efficiently generates the software necessary to properly run the automation devices. Because of the complexity involved in programming for the automation products, separate software has to be created from the beginning, each time a new product is generated. This causes an extreme problem of resources such as finding qualified programmers, time expenditures and money involved in the generation of the software package for each set of automation unit.

Further, because each software is proprietarily written with each new product or product line, there is also an issue of compatibility between systems. Overall, the software factory has made software production more efficient, but today's software factories are unable to address the specific problems and concerns of the automation industry.

Specifically in the automation industry, schedulers are typically written to support a specific set of applications. However, it is not feasible to attempt to build a scheduler that will optimally schedule for all types of systems and situations. Further, writing to support a specific set of applications is very labor intensive and not cost effective. It is not feasible to attempt to build a scheduler that will optimally schedule for all types of systems and situations.

Accordingly, it is desirable to provide a software platform that accommodates a greater efficiency in developing particular software for different purposes without having to re-write the programs from the beginning for each application. Further, it is desirable to provide a software platform that can more efficiently provide the tools for generating applications for particular applications in automation.

### SUMMARY OF THE INVENTION

The foregoing needs are met, to a great extent, by the present invention, wherein in one aspect an apparatus is provided that in some embodiments to provide a software platform that accommodates a greater efficiency in developing particular software for different purposes without having to re-write the programs from the beginning for each application.

Further, the invention provides in some embodiments a software platform that can more efficiently provide the tools for generating applications for particular applications in automation.

In accordance with one aspect of the disclosure, a software platform on a computer readable medium, includes a first unit for input representing a process; a second unit receiving the input from the first unit and converting the input into a neutral format process model; a first memory storing object information from the second unit; and a third unit being replaceable and receiving the neutral format process model information and converting into a language for processing in a runtime engine.

The third unit can further include a fourth unit changing the process model neutral format information into the process model for a scheduler; and a fifth unit receiving the scheduler format process model and scheduling based on the scheduler format process model and forwarding the output to the language for processing in the runtime engine.

The software platform can also include a second memory storing inputted scientific data and forwarding the scientific data to the third unit. The software platform can also include a sixth unit defining the expected interfaces including a definition of a neutral format and node graph. The first memory can include a first layer for application, process and transient data including data for persistence strategy and a second layer for configurable scientific, instrumentation and long term data in a scientific management system.

The instrumentation or scientific data can include correlation between data sets. The first and second layers can be stored in separate partitions of the first memory. The structure of the memory can be configurable for data mining and queries. There can be two distinct types of storage mechanisms for the first memory according to each specific layer. The first through fifth units can be modular and separate from each other and configurable for removal, change of order, or addition of other units, and schema being dynamic.

The software platform can also include a first topology of robot movers, a second topology of transfer station and robot movers, and third topology of multiple robot movers with transfer stations. The scheduler can be pluggable and configurable for additional types of schedulers. The schedulers can support a plurality of scheduling methodologies. The neutral format process model can include processes to be scheduled by a plurality of schedulers and not dependent on the format of the representation.

In another aspect of the disclosure, a method of the software platform, includes gathering user interface components and generating new targeted components; selecting a scheduler after gathering and generating the components; providing device interfaces and extending or generating new device interfaces; and configuring target application based on the device interfaces, user interfaces and selected scheduler. The scheduler can be pluggable and configurable with additional types of schedulers.

In another aspect of the disclosure, a method for a software platform, includes representing a process through a plurality of input means with a plurality of formats; receiving the data from the input means and converting the input into a neutral format process model; storing object information from the process to a database; and receiving the neutral format process model information and converting into a language for processing in a runtime engine by a replaceable and pluggable means stored on a computer readable media.

The method can have receiving the neutral format process model information and converting into the language for processing in the runtime engine including changing the process model neutral format information into the process model for a scheduler, and receiving the scheduler format process model and scheduling based on the scheduler format process model and forwarding the output to the language for processing in the runtime engine.

The method can also include storing inputted scientific data into the memory and forwarding the scientific data for preprocessing before converting into the language for processing in the runtime engine. Moreover, the method can include defining the expected interfaces including a definition of a neutral format and node graph.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of the software platform of an embodiment of the invention.

FIG. 2 is a detailed view of the separate requirements according to an embodiment of the invention.

FIG. 3 is a view of an example device to be controlled by the application created by the software platform.

FIG. 4 is another example for the extensibility of the invention.

FIG. 5 is an alternative diagram of the software platform of FIG. 1.

FIG. 6 is a flowchart for building a product.

FIG. 7 is a block diagram of a computer with a computer readable media.

### DETAILED DESCRIPTION OF THE INVENTION

An automation software platform that is described below, provides a uniform way to handle resource management. The automation software platform allows all of the applications generated through such a platform to manage the resources. The resources include, for example, all of the objects used and/or consumed by the systems such as plates, disposable tips, chemicals, etc.

Schedulers are typically written to support a specific set of applications. However, it is not feasible to attempt to build a scheduler that will optimally schedule for all types of systems and situations. Further, writing to support a specific set of applications is very labor intensive and not cost effective.

It has not been feasible to attempt to build a scheduler that will optimally schedule for all types of systems and situations. Previously, software solutions are not able to connect to other systems, there is primitive data collection and handling, limited component reuse where there is potentially only one scheduler with a large user interface, and the technology is proprietary. Further, these solutions are not efficient.

The invention provides one to easily and quickly build custom automation solutions that is capable of integrating instrumentation required by user. Further, the invention provides the integration of movers that have the best value for customers or can integrate instrumentation without a mover. The invention further contains a feature set that is easily extended, including for example customizing to the point where additional features are created by the user. Additionally, the invention accommodates a user to build systems without writing extensive lines of software code.

Examples of application of the invention can include protein crystallography, microplate stackers, devices for automation of assays, automated movers, etc. The invention provides a software factory that can be used for automated systems, but is not limited as such since it is applicable to any other type of system or application.

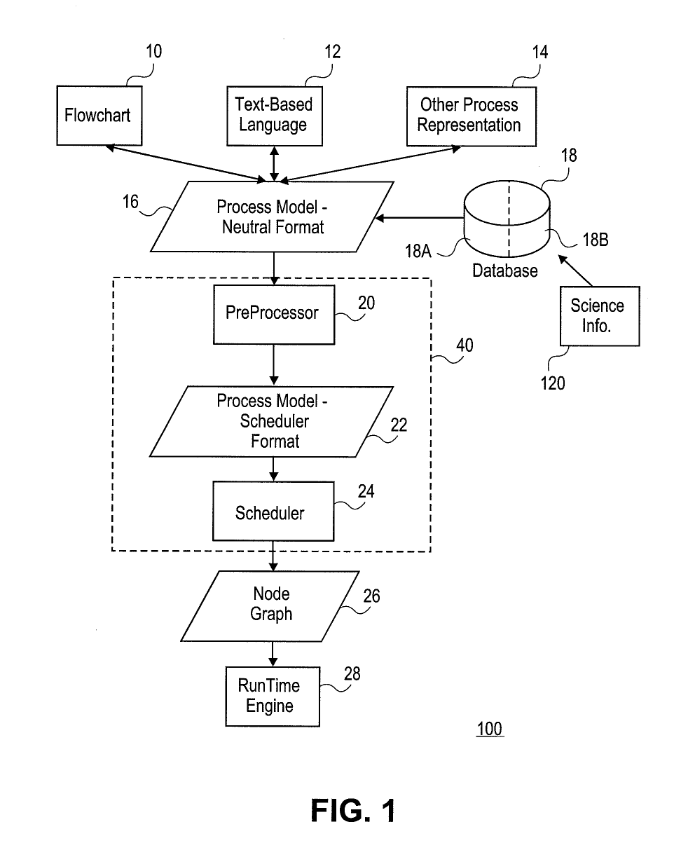

Referring to FIG. 1, a block diagram of the software platform 100 of the invention is shown. The software platform 100 can also include modules that are all or partly hardware. The software platform 100 provides the ability to change out the scheduling system used. The modules inside of the dotted square 40 are replaceable or pluggable with other modules. The invention includes an architecture that supports the ability for different types of schedulers 24 to be used, and in fact, to allow customers and third party developers to build their own schedulers 24. The software platform 100 can be customized to the choosing of the user.

A user would only need to provide the definition of the interfaces that is expected, which in this case would be the definition of the neutral format 16 and the Node Graph 26, for example.

This platform allows, for example, to change out the robot 700 that is utilized. The invention includes a generic mover interface that will allow not only, for example, devices such as robots 700, but also devices such as robots 700 from other manufacturers.

Therefore, for example, the software platform 100 can swap out or plug in different scheduling technologies. The software platform 100 allows the user to easily change out robots 700.

All robots 700 are treated the same way. One robot may perform more functions than others, but then the software code interfacing between the robot 700 and the program used to instruct the robot can be modified. For example, if a robot 700 cannot perform certain functions in hardware, software can be used to bridge the gap in the feature.

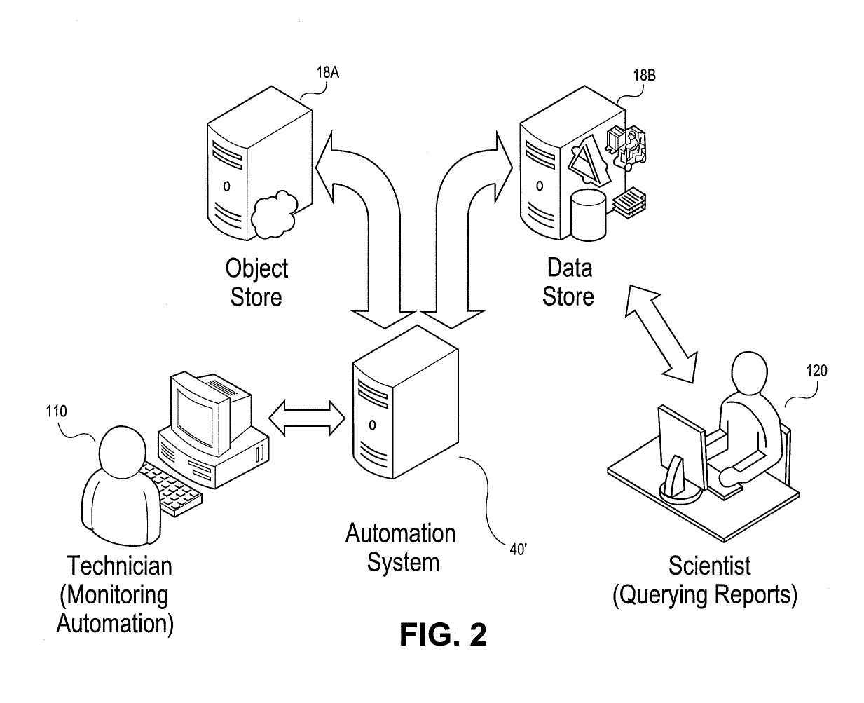

Referring to FIG. 2, instead of trying to include all the data in one mechanism, the data is broken into two parts. One is a object persistence layer stored in one partition 18a of the database 18 and the other is a configurable scientific management system stored in a second partition 18b of the database 18.

Stated in another way, the platform 100 has two sets of requirements. One is for application, process or transient data as seen in the data for persistence strategy or layer 18a, and the other is for the scientific or long term data in the scientific management system 18b. A separation is made in the type of data as the database 18 includes a data persistence strategy or layer 18a and the scientific management system partition 18b. The information can be on separate partitions of the database 18 or stored on two or a plurality of memory units. The technician monitoring the automation interfaces with the automation system 40′, and the object based information, is stored on the object store or the persistence layer 18a through the automation system 40′. On the other hand, the technician entering information through, for example, querying reports, get stored directly in the data store in the scientific management system memory area 18b.

These two sets of requirements are very different. For the application data of the platform 100, one needs dynamic schema generation, low maintenance, and an object-oriented design.

Dynamic schema generation means that the scheme is allowed to change. Every system that is built is different, and so the user cannot be building new database schema's for every system that is made. Even if the user did, management of this would be very difficult in that there are so many variables to contend with, and thus increased costs through increased time spent in programming for each different unit.

Low maintenance exists in the software platform 100, since when a user upgrades the system, it has to be done as smoothly and quickly as possible, without risking customer data. The software platform 100 is very modular, so components may be added and upgraded separately. The database schema must be resilient to this type of change.

The software platform 100 can be an object-oriented design. The software platform 100 needs to easily persist object data. The device interface writers often do not have database skills, but still need to persist information and so an object oriented design accommodates for less programming skills and therefore, lowered costs and need of certain expertise in the field to generate the software.

Further, patterns can be generated through the object oriented language used, including, for example, general repeatable solutions to commonly occurring problems in software design. There can be frameworks included, for example, with object-oriented reusable designs for software systems (or subsystems). In addition, certain guidance can be included in the platform software. For example, the best practices for building applications using the factory can be included. Documentation can also be selected and viewed, along with visual studio templates and development tools and aids.

In addition, as related to the application data, data changes constantly, but does not build over time. The data in the application data is dynamic.

For our scientific or long term data in the data store 18b, there is a flexible storage mechanism, subset of application data needs to combine with instrumentation or scientific data, the scientific data can be in a structure that is data mined, regulatory compliance, and lends itself to data warehouse structure.

The flexible storage mechanism includes different database vendors, and maybe no database. That is there can be a web service or text files rather than a database or other alternative equivalent structures or methods.

The subset of application data needs to combine with instrumentation or scientific data 18b, where it includes correlation between data sets. This includes system logs and auditing, and snapshots of live automation data. The software platform 100 provides correlation between the data sets, which can include, for example, system logs and auditing. Further, the correlation between data sets includes snapshots of live automation data as taken from the automation system 40′.

The information stored in the database 18 can be in a structure that is data mined. A certain structure can be given in order to make data mining more efficient. The structure given for data mining includes being analyzed and reported against and being optimized for this type of access.

Further, the software platform 100 provides for compliance with certain regulatory standards, include for example 21 CFR Part 11 compliance. The 21 CFR Part 11 compliance is United States code of federal regulations that relates to the FDA (Federal Drug Administration) guidelines on electronic records and electronic signatures. Specifically, the code requires FDA regulated industries to implement controls and documentation for software and systems that process many forms of data. The software platform 100 can also be compliant with other related regulations from other countries. Since the platform 100 accommodates customization, the components can be made compliant with other state or country regulations.

Compliance to such regulations can be obtained, for example, by locking down the database to prevent changes, or record all modifications. Other similar measures can be performed in order to meet certain regulation guidelines.

Additionally, the software platform 100, lends itself to data warehouse structure. Further, the customizability of the software platform 100 will allow the software to be in other types of structures also.

The software platform 100 will not try to combine these requirements into a single solution. Since the software platform includes these two very different set of requirements, the choice is to have two types of storage mechanisms that can be optimized for each set of requirements.

To separate these two concerns, data is organized as follows. The application data 18a is the metadata of the automated system 40′. In addition, scientific data 18b is the result of running the automated system 40′ as seen in FIG. 2.

Therefore, the software platform 100 provides for a freedom of choice, in, for example, instruments and robotic movers. There is also a scalable solution, fitted to automated systems form bench tops to large integrated labs. There is also flexibility to adapt to changing requirements. The software platform 100 can handle a plurality of variables, but the software platform 100 can also handle a static program.

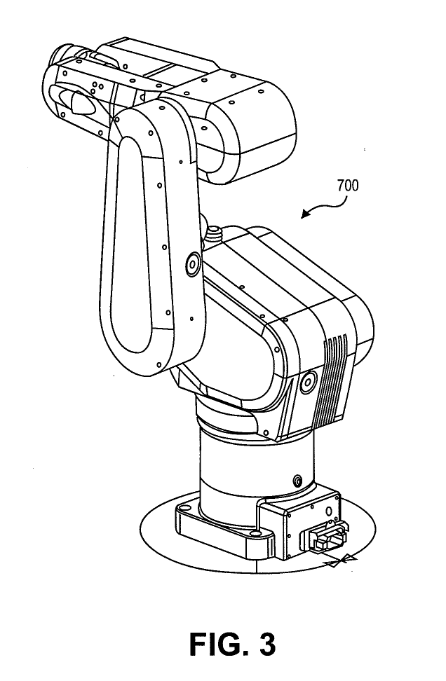

The software platform also provides for extensibility as mentioned above. For example, referring to FIG. 3, the software platform 100 provides for not only robot movers 700 of one manufacturer, but also robot movers of other manufacturers. Therefore, the software platform 100 will support everything from articulated robots to simple collections of motors and actuators.

The software platform 100 generates software that provides for a uniform, efficient interface to all robot movers 700, rather than each one having a separate interface to deal with by the user. Further, the software platform allows for syntactic inferential motion planner technology to work with all of the movers 700. The application or software that is generated by the software platform 100 instruct the mover 700 the destination location. Further, the syntactic inferential motion planner uses a taught path and region information to find an efficient route.

Recovery from errors is also much simpler in that the planner uses the geometry in the motion database to find a safe way to reposition the robot mover 700 with minimal user intervention.

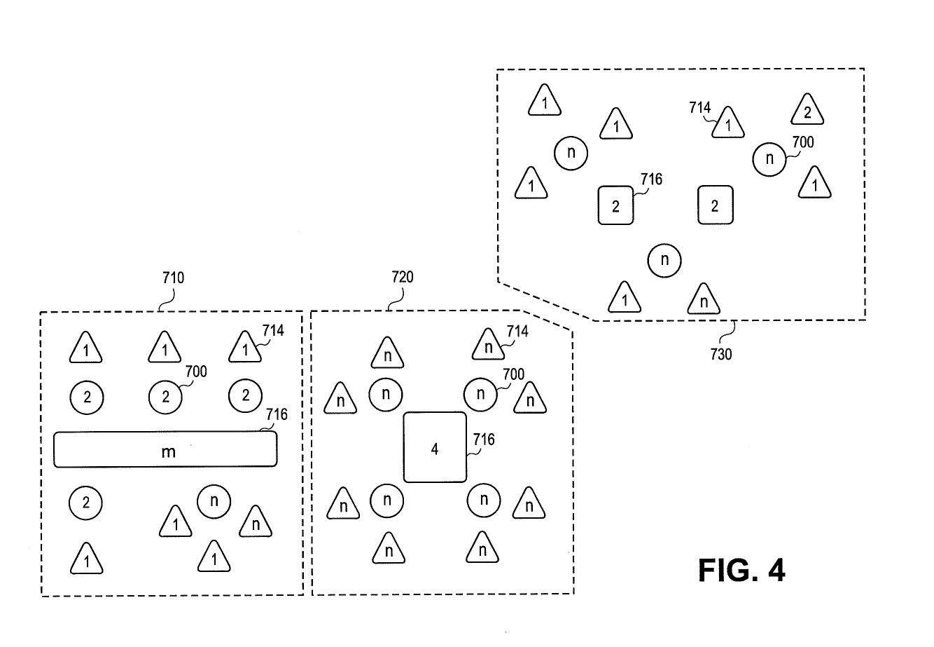

Referring to FIG. 4, the extensibility of the software platform 100 also includes the mover 700 topology. This allows for any combination of moving technology, including movers connect nests and transfer connect movers. Referring to the first topology 710, the movers 700 (with N being the maximum number of devices, ranging from n to 2) are shown in the central belt with (transfer 716, with N=M as the maximum number of movers) fixed robot movers 700 and also including instruments 714 (with N=1 being maximum number of nests). The second topology 720 include the central rotation station (transfer 716) with fixed robot movers 700, where the maximum number of movers 700 is 4 for the transfer station 716. In the third topology 730, there are multiple fixed robots with swap stations (transfer 716). In such a topology 730, one can also represent two belts with a flip connecting them.

The software platform 100 accommodates not only robot movers 700, but also other devices and systems. Such devices and systems can be controlled through the software written by the software platform 100.

As mentioned above, the software platform 100 is open to all instruments and not limited to the ones shown in the examples. There is also the ability to multitask on devices that support it and the device is defined by its components. A device with more than one component may be able to multitask depending on the operation requirements. Additionally, there is a fixed functionally connectedness with containerless operations and environmental monitoring that can be performed.

A plurality of utilities can be used, including supporting natively an uninterrupted power supply. Also, the software platform 100 can accommodate a plurality of different input/output (I/O) configurations and devices, including instruments 714 and movers 700 that contain I/O points, for example, unused I/O on a liquid handler. The software platform 100 also works across the distributed infrastructure.

The schedulers, as mentioned above, are pluggable, including the ability to plug into third party schedulers. In addition, the software platform can support many different scheduling methodologies. For example, one can calculate schedule in advance with the advantage of guaranteed timings and optimize for throughput. The scheduling can also be dynamic with the schedule be used during runtime using a prioritized list. The advantage for dynamic scheduling is to make decisions at runtime and adjust schedule in real-time or almost real-time. Additionally, one can perform hybrid scheduling with statistically scheduling as much possible in advance. The advantage is to guarantee timings and be able to make decisions at runtime.

The software platform 100 of the invention allows a user to build automated solutions that are composed of discrete and independent functional pieces. These pieces are integrated in a host environment to form the solution. There is a provision of an architecture and implementation that assists in building automated systems. This allows for a separation of the different concerns, while allowing for modularity and extensibility as shown above. The invention of the software platform provides for support for implementation of a plurality of patterns for automation systems, but is not limited automation systems. The software platform 100 can be used to generate applications for any type of device or system to perform a variety of different methods.

Referring back to FIG. 1, representations of the process are inputted into the process model-neutral format. The process can be represented, for example, as a flowchart 10, or text-based language 12 (e.g., object oriented C++, JAVA, etc.), or other process representation 14 that is then converted into a process model-neutral format 16. These are representations of the process (10, 12 and 14) that we are trying to schedule. For example, there may have to be a threshold on the feedback when counting the number of cells. That information can be inputted at this top level. The process model 16 is neutral in format as compared to the original process representations 10, 12 and 14. All the process representations 10, 12 and 14 are modeled the same in the process model-neutral format 16. This information from the process model in the neutral format 16 is then stored in the database 18. Specifically, the process model 16 is stored in the object database partition 18b. Therefore, the data for the running of the automation is stored in the database partition 18a, while the information for the science is stored in the partition 18b from the science information input 120. The data transmission in FIG. 1 between the process model-neutral format 16 and the database 18 relates to the object database partition 18b.

Then, the information from the process model 16 is sent to the pre-processor 20 or model processor 22. The pre-processor 20 converts the information into the process model for the scheduler. The pre-processor takes the information from the process model 16 and processes it, by changing for example implied instruction into real bits. This is done because the scheduler 24 itself does not know those assumptions or implications. The process model in scheduler format 22 takes the information from the pre-processor 20 and basically takes condensed instructions originally from the process model-neutral format 16 and expands the information out. Then that information from the process model 22 which is now in the scheduler format, is fed into the scheduler 24, which picks the process model and schedules based on, for example, resource restrictions and constraints. Each one of the process-model neutral format 16, process model-scheduler format 22 and the node graph 26 is considered a language. The scheduler then produces a node graph 26 which is a dependency graph. The node graph 26 is in a language that the scheduler uses to talk to the runtime engine 28. The runtime engine 28 knows how to understand running a node graph 26. The run-time engine 28 runs the schedule on the device or system that the scheduler 24 created.

Additional feedback loops can be included within the modules, including the modules in the replaceable module 40 and other more complex flow paths. There can be multiple iterations in each of the process. There can also be decisions, etc. included in the path. There can be information that is fed back to the scheduler 24 in the feedback loops with regard to modules shown. The scheduler 24 comes up with a schedule based on the constraints that have been imposed. The process to the scheduler 24 is therefore, serialized in the pluggable unit 40, unrolling the feedback loops.

The replaceable module 40 shows that not all schedulers are the same. As mentioned above, there are static schedulers, dynamic schedulers and hybrid schedulers. Each one type can be customized in the replaceable module 40.

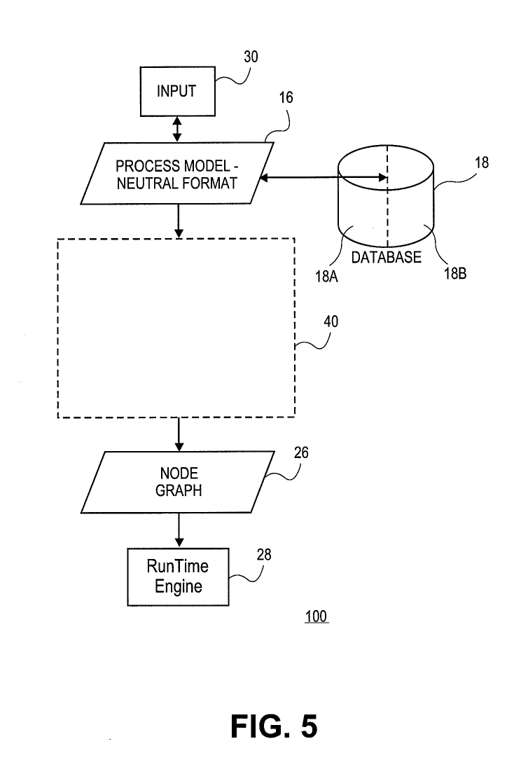

Alternatively, referring to FIG. 5, the software platform 100 can also be viewed as having an object oriented input 30 being fed into the process model in neutral format, and then being processed in the replaceable unit 40, accommodating the conversion into the node graph 26 for use by the runtime engine 28. The replaceable unit 40 can be any time of processing and program instruction that can be run by the run-time engine 28. Therefore, the software platform is not limited to automation systems. The input 30 can be object oriented or any type of input that depicts the processes to be processed and ran by the runtime engine 28.

The persistence layer, can be upgraded. When saving a change, it will modify the scheme and database. For example, when there is an upgrade for a component in the system, and when there is an attempt to perform a process, the logic will notice the change and modify the scheme in the database. Therefore, there is no need for upgrade scripts and it is handled dynamically.

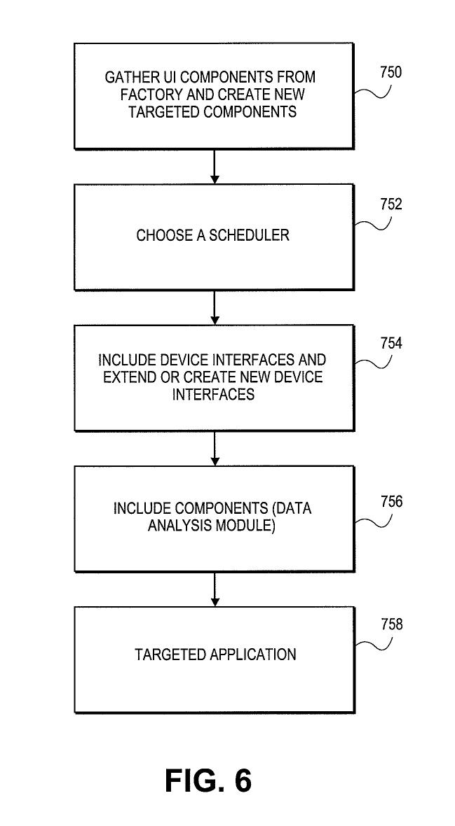

Referring to FIG. 6, an example of building a product includes gathering a user interface components from the factory and/or create new targeted components (step 750). A scheduler is selected (step 752) after gathering the components. Thereafter, one includes device interfaces and extend or create new ones (step 754). Then one can optionally include components including data analysis module (step 756) which can analyze the data received. Finally, the method creates the targeted application (step 758).

The software platform is made around a dependency injection or inversion control system that is responsible for building the objects. The dependency injection provide the framework that is loosely-coupled. The foundation links objects together instead of object linking themselves. The framework provides for the software platform, to build libraries of components that can be reused in different scenarios or components that can be changed to fit different environments. The components can be viewed as modules, where the modules can contain one or more of models, services, and device interfaces. The models, controllers and views are the user interface elements. The services are the runtime, schedulers and application data and device interfaces are instruments and movers as shown above.

Messages are any interaction between a device and the user including error messages or other information queries. The messages can be customized by the user and can be logged.

There is also error handling with respect to attended and unattended modes. The unattended mode is if a plate is missing and system continues processing. Further instruments can be pooled or grouped to add redundant behavior. If there is an error in one instrument, the system itself will not halt, but throughput may be reduced or have no affect as supported by the scheduler.

The invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The invention can include the computer-readable medium having stored thereon a data structure including a plurality of fields containing data representing the techniques of the invention.

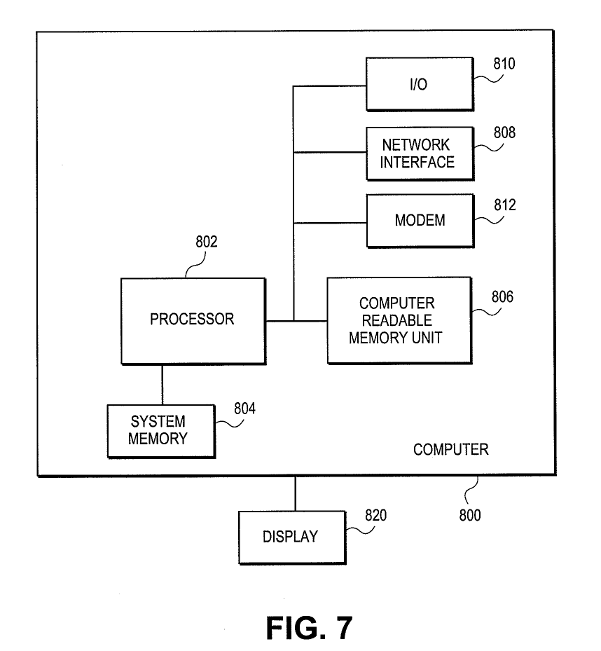

Referring to FIG. 7, an example of a computer, but not limited to this example of the computer 800, that can read computer readable media 806 that includes computer-executable instructions of the invention. The computer 800 includes a processor 802 that uses the system memory 804 and a computer readable memory device 806 that includes certain computer readable recording media. A system bus connects the processor 802 to a network interface 808, modem 812 or other interface that accommodates a connection to another computer or network such as the Internet. The system bus may also include an input and output (I/O) interface 810 that accommodate connection to a variety of other devices. Furthermore, the computer 800 can output through, for example, the I/O 810, data for display on a display device 820. The database 18, for example, can be stored in the computer readable memory unit 806.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A software platform on a computer readable medium, comprising:
a first unit for input representing a process;
a second unit receiving the input from the first unit and converting the input into a neutral format process model;
a first memory storing object information from the second unit; and
a third unit being replaceable and receiving the neutral format process model information and converting into a language for processing in a runtime engine.

2. The software platform of claim 1, wherein the third unit further comprises:
a fourth unit changing the process model neutral format information into the process model for a scheduler; and
a fifth unit receiving the scheduler format process model and scheduling based on the scheduler format process model and forwarding the output to the language for processing in the runtime engine.

3. The software platform of claim 1, further comprising a second memory storing inputted scientific data and forwarding the scientific data to the third unit.

4. The software platform of claim 1, further comprising of a sixth unit defining the expected interfaces including a definition of a neutral format and node graph.

5. The software platform of claim 1, wherein the first memory includes a first layer for application, process and transient data including data for persistence strategy and a second layer for configurable scientific, instrumentation and long term data in a scientific management system.

6. The software platform of claim 5, wherein the instrumentation or scientific data includes correlation between data sets.

7. The software platform of claim 5, wherein the first and second layers are stored in separate partitions of the first memory.

8. The software platform of claim 5, wherein the structure of the memory being configurable for data mining and queries.

9. The software platform of claim 5, wherein there is two distinct types of storage mechanisms for the first memory according to each specific layer.

10. The software platform of claim 2, wherein the first through fifth units are modular and separate from each other and configurable for removal, change of order, or addition of other units, and schema being dynamic.

11. The software platform of claim 2, further comprising of a first topology of robot movers, a second topology of transfer station and robot movers, and third topology of multiple robot movers with transfer stations.

12. The software platform of claim 2, wherein the scheduler is pluggable and configurable for additional types of schedulers.

13. The software platform of claim 12, wherein the schedulers support a plurality of scheduling methodologies.

14. The software platform of claim 1, wherein the neutral format process model includes processes to be scheduled by a plurality of schedulers and not dependent on the format of the representation.

15. A method of a software platform, comprising:
gathering user interface components and generating new targeted components;
selecting a scheduler after gathering and generating the components;
providing device interfaces and extending or generating new device interfaces; and
configuring target application based on the device interfaces, user interfaces and selected scheduler.

16. The method of claim 15, wherein the scheduler is pluggable and configurable with additional types of schedulers.

17. A method for a software platform, comprising:
representing a process through a plurality of input means with a plurality of formats;
receiving the data from the input means and converting the input into a neutral format process model;
storing object information from the process to a database; and
receiving the neutral format process model information and converting into a language for processing in a runtime engine by a replaceable and pluggable means stored on a computer readable media.

18. The method of claim 17, wherein receiving the neutral format process model information and converting into the language for processing in the runtime engine comprises:
changing the process model neutral format information into the process model for a scheduler;
receiving the scheduler format process model and scheduling based on the scheduler format process model and forwarding the output to the language for processing in the runtime engine.

19. The method of claim 18, further comprising storing inputted scientific data into the memory and forwarding the scientific data for preprocessing before converting into the language for processing in the runtime engine.

20. The method of claim 19, further comprising defining the expected interfaces including a definition of a neutral format and node graph.

21. The method of claim 18, wherein the first memory includes a first layer for application, process and transient data including data for persistence strategy and a second layer for configurable scientific, instrumentation and long term data in the scientific management system.

22. The method of claim 21, wherein the first and second layers are stored in separate partitions of the first memory with two distinct types of storage mechanisms for the first memory according to each specific layer, and with a schema being dynamic.
